(19) United States
(12) Patent Application Publication
(10) Pub. No.: US 2019/0264695 A1
(43) Pub. Date: Aug. 29, 2019

(54) CENTRIFUGAL FAN

(71) Applicant: Nidec Corporation, Kyoto (JP)

(72) Inventors: Tomoyuki TSUKAMOTO, Kyoto (JP); Kazuhiko FUKUSHIMA, Kyoto (JP)

(21) Appl. No.: 16/267,569

(22) Filed: Feb. 5, 2019

(30) Foreign Application Priority Data
Feb. 26, 2018 (JP) 2018-031909

(51) Int. Cl. F04D 17/16; F04D 25/06; F04D 29/28; F04D 29/62; F04D 29/42; F04D 29/66

(52) U.S. Cl. CPC F04D 17/16; F04D 25/0606; F04D 29/281; F04D 29/288; F04D 29/624; F05B 2280/6012; F04D 29/666; F05B 2240/301; F05B 2240/14; F05B 2230/232; F05B 2260/96; F04D 29/4226

(57) ABSTRACT

A centrifugal fan includes a motor, a support body, a rotating body, and a housing. The motor includes a rotor hub that rotates around a central axis extending up and down. The support body is fixed to the rotor hub and rotates together with the rotor hub. The rotating body is different from the support body in material and is a continuous porous body. The housing accommodates the rotating body, the support body, and the motor. The housing includes an air inlet open in an axial direction and at least one air outlet open in a radial direction. A radially inner surface of the rotating body opposes a radially outer surface of the rotor hub with a gap interposed therebetween. The rotating body is fixed to the support body to be replaceable.

### CROSS REFERENCE TO RELATED APPLICATIONS

This application claims the benefit of priority to Japanese Patent Application No. 2018-031909 filed on Feb. 26, 2018. The entire contents of this application are hereby incorporated herein by reference.

### BACKGROUND OF THE INVENTION

### 1. Field of the Invention

The present disclosure relates to a centrifugal fan.

### 2. Description of the Related Art

General centrifugal fans rotate a plurality of blades to convert an incoming airflow parallel to the axial direction into a radial airflow and discharge the radial airflow. The centrifugal fan is mounted, for example, as a cooling fan, to an electronic device such as a notebook personal computer. Alternatively, the centrifugal fan is used as a fan for a mask. The centrifugal fan to be mounted to the electronic device such as the notebook personal computer is required to have noise reduction. Similarly, the centrifugal fan used as the fan for the mask is required to have noise reduction.

However, a general centrifugal fan rotates a plurality of blades to generate airflow, thereby sucking outside air into the inside of a housing of the centrifugal fan. As a result, there is a case where foreign substances are sucked simultaneously with the outside air, and the foreign substances adhere to the blade so that the blade becomes dirty or the foreign substances collide with the blade so that the blade is damaged. When the blade becomes dirty or when the blade is damaged, it is necessary to replace the blade, but it is not easy to replace the blade in the general centrifugal fan. Therefore, when it is necessary to replace the blade, the centrifugal fan itself is replaced in many cases.

### SUMMARY OF THE INVENTION

A centrifugal fan according to an exemplary embodiment of the present disclosure includes a motor, a support body, a rotating body, and a housing. The motor includes a rotor hub. The rotor hub rotates about a central axis extending up and down. The support body is fixed to the rotor hub and rotates together with the rotor hub. The rotating body is different in material from the support body. The rotating body is a continuous porous body. The housing accommodates the rotating body, the support body, and the motor. The housing includes an air inlet open in an axial direction and at least one air outlet open in a radial direction. A radially inner surface of the rotating body opposes a radially outer surface of the rotor hub with a gap interposed therebetween. The rotating body is fixed to the support body to be replaceable.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a plan view of a centrifugal fan according to a first exemplary embodiment of the present disclosure.

FIG. 1B is a plan view illustrating the inside of the centrifugal fan according to the first exemplary embodiment of the present disclosure.

FIG. 2 is a perspective view illustrating the inside of the centrifugal fan according to the first exemplary embodiment of the present disclosure.

FIG. 3 is a cross-sectional view illustrating a portion of the centrifugal fan according to the first exemplary embodiment of the present disclosure.

FIG. 4A is a plan view illustrating an example of an arrangement of convex portions according to the first exemplary embodiment of the present disclosure.

FIG. 4B is a plan view illustrating another example of the arrangement of the convex portions according to the first exemplary embodiment of the present disclosure.

FIG. 5A is a side view illustrating the convex portion according to the first exemplary embodiment of the present disclosure.

FIG. 5B is a side view illustrating another example of the convex portion according to the first exemplary embodiment of the present disclosure.

FIG. 6 is a cross-sectional view illustrating a portion of a centrifugal fan according to a second exemplary embodiment of the present disclosure.

FIG. 7 is a plan view illustrating an example of an arrangement of convex portions according to the second exemplary embodiment of the present disclosure.

FIG. 8A is a perspective view illustrating another example of the convex portion according to the second exemplary embodiment of the present disclosure.

FIG. 8B is a side view illustrating another example of the convex portion according to the second exemplary embodiment of the present disclosure.

FIG. 9 is a cross-sectional view of the centrifugal fan according to the third exemplary embodiment of the present disclosure.

FIG. 10 is a cross-sectional view illustrating another example of an arrangement of convex portions according to a third exemplary embodiment of the present disclosure.

FIG. 11 is a cross-sectional view illustrating a portion of a centrifugal fan according to a fourth exemplary embodiment of the present disclosure.

FIG. 12 is a plan view illustrating an arrangement of convex portions according to the fourth exemplary embodiment of the present disclosure.

FIG. 13 is a cross-sectional view illustrating a portion of a centrifugal fan according to a fifth exemplary embodiment of the present disclosure.

FIG. 14A is a side view illustrating an arrangement of convex portions according to the fifth exemplary embodiment of the present disclosure.

FIG. 14B is a side view illustrating another example of a convex portion according to the fifth exemplary embodiment of the present disclosure.

FIG. 15 is a cross-sectional view illustrating a portion of a centrifugal fan according to a sixth exemplary embodiment of the present disclosure.

FIG. 16 is a plan view illustrating a support body according to a seventh exemplary embodiment of the present disclosure.

FIG. 17 is a cross-sectional view illustrating a portion of a centrifugal fan according to the seventh exemplary embodiment of the present disclosure.

### DETAILED DESCRIPTION OF THE PREFERRED EMBODIMENTS

Hereinafter, exemplary embodiments of the present disclosure will be described with reference to the drawings. However, the present disclosure is not limited to the following embodiments. In the drawings, the same or corresponding parts will be denoted by the same reference signs, and descriptions thereof will not be repeated. Further, points for which descriptions overlap each other will be sometimes omitted as appropriate.

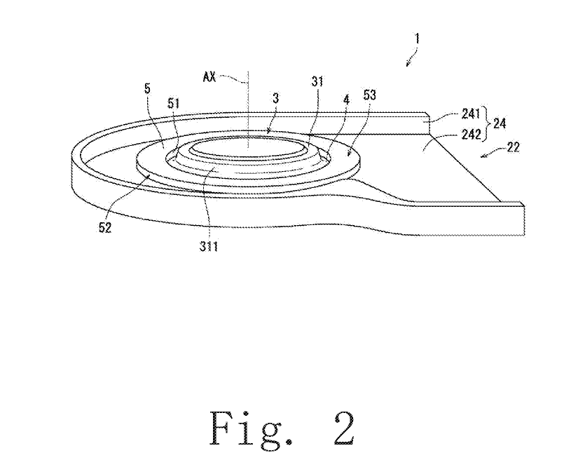

In the present specification, a direction in which a central axis AX (see FIG. 2) of a motor 3 extends will be described as an up-down direction for the sake of convenience. However, the up-down direction is defined for convenience of the description, and there is no intention that the direction of the central axis AX coincides with the vertical direction. In the present specification, a direction parallel to the central axis AX of the motor 3 will be referred to as an “axial direction”, a radial direction and a circumferential direction around the central axis AX of the motor 3 will be referred to as a “radial direction” and a “circumferential direction”. However, in practicality, there is no intention to limit the orientation during use of the centrifugal fan according to the present disclosure to such definitions. Incidentally, the “parallel direction” includes a substantially parallel direction.

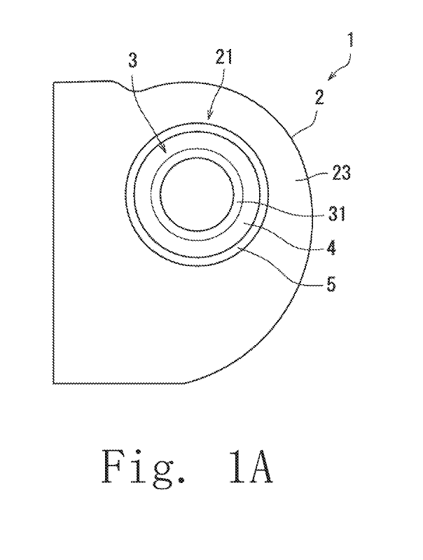

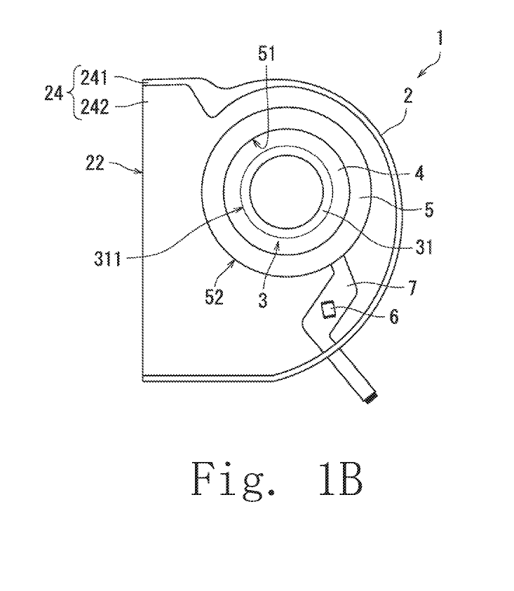

FIG. 1A is a plan view illustrating a centrifugal fan 1 according to a first embodiment. As illustrated in FIG. 1A, the centrifugal fan 1 includes a housing 2, a motor 3, a support body 4, and an annular rotating body 5.

The housing 2 has an air inlet 21 that is open in the axial direction. Specifically, the housing 2 has a cover member 23, and the cover member 23 has the air inlet 21. In the present embodiment, the cover member 23 forms an upper wall portion of the housing 2.

FIG. 1B is a plan view illustrating the inside of the centrifugal fan 1 according to the first embodiment. Specifically, FIG. 1B illustrates the centrifugal fan 1 from which the cover member 23 illustrated in FIG. 1A has been removed. As illustrated in FIG. 1B, the housing 2 accommodates the motor 3, the support body 4, and the rotating body 5. Further, the housing 2 has an air outlet 22 that is open in the radial direction. Specifically, the housing 2 has a case member 24. The case member 24 is covered with the cover member 23 illustrated in FIG. 1A. The case member 24 has a side wall portion 241, and the side wall portion 241 has an air outlet 22. Further, the case member 24 has a lower wall portion 242. The lower wall portion 242 opposes the cover member 23 illustrated in FIG. 1A in the axial direction.

As illustrated in FIG. 1B, the centrifugal fan 1 further includes a motor driver 6 and a wiring board 7. The motor driver 6 generates a drive signal to d rive the motor 3 based on a control signal transmitted from an external controller. The motor driver 6 is mounted to the wiring board 7. The wiring board 7 receives the control signal transmitted from the external controller and transmits the received control signal to the motor driver 6. Further, the wiring board 7 transmits the drive signal generated by the motor driver 6 to the motor 3. The housing 2 further accommodates the motor driver 6. In the present embodiment, the housing 2 accommodates a portion of the wiring board 7.

FIG. 2 is a perspective view illustrating the inside of the centrifugal fan 1 according to the first embodiment. Specifically, FIG. 2 illustrates the centrifugal fan 1 from which the cover member 23 illustrated in FIG. 1A has been removed. As illustrated in FIGS. 1A, 1B, and 2, the motor 3 has a rotor hub 31 that rotates about a central axis AX. The rotor hub 31 has a radially outer surface 311. The support body 4 is fixed to the rotor hub 31 and rotates together with the rotor hub 31. Specifically, the support body 4 protrudes in the radial direction from the rotor hub 31. The rotor hub 31 protrudes axially upward from a proximal end portion of the support body 4. Incidentally, the rotor hub 31 and the support body 4 may be integrated or may be separate bodies.

The rotating body 5 is fixed to the support body 4 and extends in the circumferential direction. Specifically, the rotating body 5 is fixed to the support body 4 to be replaceable. The rotating body 5 has a radially inner surface 51 and a radially outer surface 52. The radially inner surface 51 of the rotating body 5 opposes the radially outer surface 311 of the rotor hub 31 in the radial direction with a gap interposed therebetween. The radially outer surface 52 of the rotating body 5 opposes the side wall portion 241 in the radial direction with a gap interposed therebetween. Further, the rotating body 5 has an axially upper surface 53. The axially upper surface 53 opposes the cover member 23 in the axial direction with a gap interposed therebetween. In other words, the axially upper surface 53 is the surface of the rotating body 5 on the air inlet 21 side.

A material of the rotating body 5 is different from a material of the support body 4. The material of the rotating body 5 is, for example, a continuous porous body such as foamed urethane. The continuous porous body is a material which has a plurality of continuous air holes such that a wall between adjacent air holes is open and through which a fluid such as a gas can pass. For example, the material of the rotating body 5 may be an open-cell structure. The open-cell structure is a material which has a plurality of continuous air cells (air holes) such that a wall between adjacent air cells is open and through which a fluid such as a gas can pass. The material of the support body 4 is, for example, hard plastic.

Next, an operation of the centrifugal fan 1 will be described with reference to FIGS. 1A, 1B, and 2. When the rotor hub 31 rotates in the centrifugal fan 1, the support body 4 and the rotating body 5 rotate in the circumferential direction about the central axis AX. When the rotating body 5 rotates in the circumferential direction, the air inside the rotating body 5 moves to the radially outer surface 52 of the rotating body 5 by a centrifugal force and is sent from the radially outer surface 52 of the rotating body 5 to the outside of the rotating body 5. The air sent from the radially outer surface 52 of the rotating body 5 to the outside of the rotating body 5 is sent to the outside from the air outlet 22. On the other hand, when the air inside the rotating body 5 is sent to the outside of the rotating body 5, the air between the rotor hub 31 and the radially inner surface 51 of the rotating body 5 is sucked from the radially inner surface 51 of the rotating body 5 into the inside of the rotating body 5. As a result, the air outside the housing 2 is sucked into a space between the rotor hub 31 inside the housing 2 and the radially inner surface 51 of the rotating body 5 from the air inlet 21. Therefore, when the rotor hub 31 rotates, the air is sucked into the inside of the housing 2 from the air inlet 21, and the air sucked into the interior of the housing 2 is blown to the outside of the housing 2 from the air outlet 22.

When the rotating body 5 rotates in the circumferential direction, friction is generated between the axially upper surface 53 of the rotating body 5 and the air. As a result, the air existing in the gap between the axially upper surface 53 of the rotating body 5 and the cover member 23 moves to the radially outer surface 52 side of the rotating body 5. Therefore, airflow (reverse flow) flowing from the gap between the axially upper surface 53 of the rotating body 5 and the cover member 23 to the air inlet 21 hardly occurs. Accordingly, the efficiency of the centrifugal fan 1 can be improved.

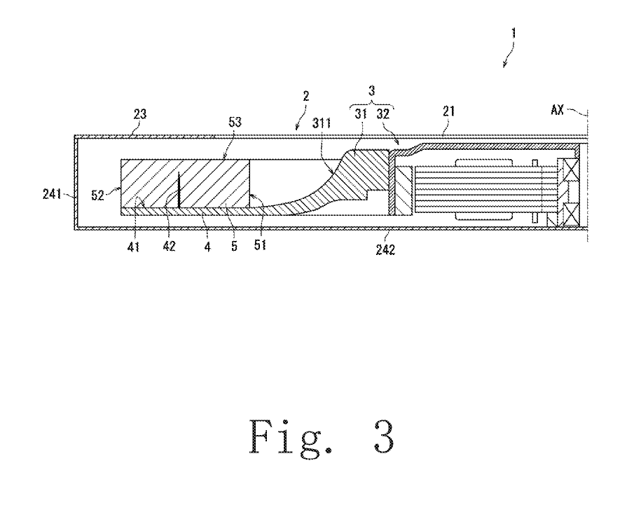

Next, the support body 4 will be further described with reference to FIG. 3. FIG. 3 is a cross-sectional view illustrating a portion of the centrifugal fan 1 according to the first embodiment. Specifically, FIG. 3 illustrates cross sections of the housing 2, the motor 3, the support body 4, and the rotating body 5.

As illustrated in FIG. 3, the motor 3 has a motor unit 32. The motor unit 32 rotates the rotor hub 31 in the circumferential direction about the central axis AX. The support body 4 has an axially upper surface 41 and at least one convex portion 42. The axially upper surface 41 opposes the cover member 23 in the axial direction. The rotating body 5 is arranged on the axially upper surface 41 of the support body 4. Incidentally, it is unnecessary to clearly define a boundary between the rotor hub 31 and the support body 4 as long as the rotor hub 31 has the radially outer surface 311 and the support body 4 has the axially upper surface 41.

The convex portion 42 extends axially upward from the axially upper surface 41 of the support body 4. In other words, the convex portion 42 extends to the air inlet 21 side. In the present embodiment, the convex portion 42 is positioned on a side closer to the radially outer surface 52 side of the rotating body 5 than the radially inner surface 51 of the rotating body 5 and on a side closer to the radially inner surface 51 of the rotating body 5 than the radially outer surface 52 of the rotating body 5. In other words, the convex portion 42 is positioned between the radially inner surface 51 of the rotating body 5 and the radially outer surface 52 of the rotating body 5. Further, a length of the convex portion 42 in the axial direction is longer than a half of the length of the rotating body 5 in the axial direction. Incidentally, the support body 4 and the convex portion 42 may be formed to be integrated or may be separate bodies.

According to the present embodiment, the convex portion can pierce the rotating body 5. Alternatively, the convex portion 42 can be hooked by a pore of the rotating body 5. Therefore, the rotating body 5 can be fixed to be replaceable. Further, the length of the convex portion 42 in the axial direction is longer than a half of the length of the rotating body 5 in the axial direction. As a result, the center of gravity of the rotating body 5 is positioned in a range fixed by the convex portion 42, and thus, the rotating body 5 can be more stably fixed.

The centrifugal fan 1 according to the first embodiment has been described above with reference to FIGS. 1A, 1B, 2, and 3. According to the present embodiment, noise can be reduced by using the annular rotating body made of the continuous porous body. In other words, it is possible to achieve noise reduction. Specifically, in a centrifugal fan using a rotating body having a plurality of blades, turbulent flow that causes noise is generated due to a pressure difference generated in the vicinity of a radially distal end of each blade. According to the present embodiment, however, since the annular rotating body made of the continuous porous body is rotated, the turbulent flow is less likely to occur as compared with the centrifugal fan that rotates the plurality of blades. Therefore, the noise can be reduced.

According to the present embodiment, the rotating body 5 is fixed to the support body 4 to be replaceable. Therefore, the rotating body 5 can be easily replaced. For example, the rotating body 5 can be replaced when the rotating body 5 becomes dirty or when the rotating body 5 is damaged.

According to the present embodiment, the radially inner surface 51 of the rotating body 5 opposes the radially outer surface 311 of the rotor hub 31 with the gap interposed therebetween. Therefore, air easily enters the inside of the rotating body 5 from the radially inner surface 51 of the rotating body 5, and it is possible to increase the amount of air blowing of the centrifugal fan 1.

According to the present embodiment, since the rotating body 5 is configured using the continuous porous body, it is possible to reduce a weight of the rotating body 5. Therefore, it is easy to take eccentric balance of the rotating body 5. For example, it is possible to achieve weight reduction of the rotating body 5 by using the open-cell structure as the material of the rotating body 5. Further, it is possible to rate the rotating body 5 at a high speed by achieving the weight reduction of the rotating body 5. Since the rotating body 5 is rotated at a high speed, it is possible to stably rotate the rotating body 5 even if a load fluctuates.

According to the present embodiment, the axially upper surface 53 of the rotating body 5 moves the air to the radially outer surface 52 side of the rotating body 5. Therefore, the amount of air blowing of the centrifugal fan 1 can be increased.

According to the present embodiment, the open-cell structure can be used as the material of the rotating body 5. Since the open-cell structure is a material which is easily processed, it is possible to easily manufacture the rotating body 5 by using the open-cell structure as the material of the rotating body 5.

Since the open-cell structure is used as the material of the rotating body 5, the rotating body 5 can be made soft. When the rotating body 5 is soft, the housing 2 is not easily damaged even if the rotating body 5 comes into contact with the housing 2. Therefore, it is possible to narrow the gap between the rotating body 5 and the housing 2 by using the open-cell structure as the material of the rotating body 5 according to the present embodiment. In other words, it is possible to achieve size reduction of the centrifugal fan 1.

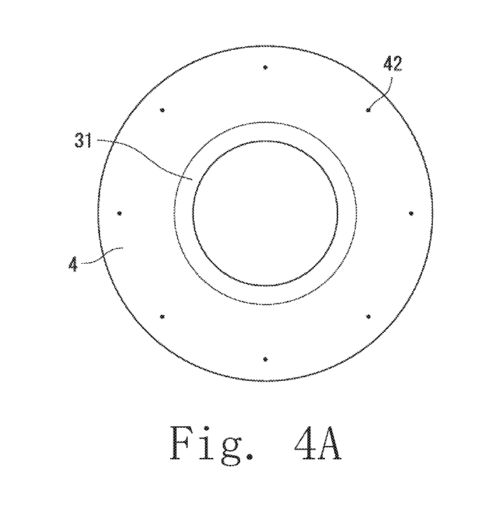

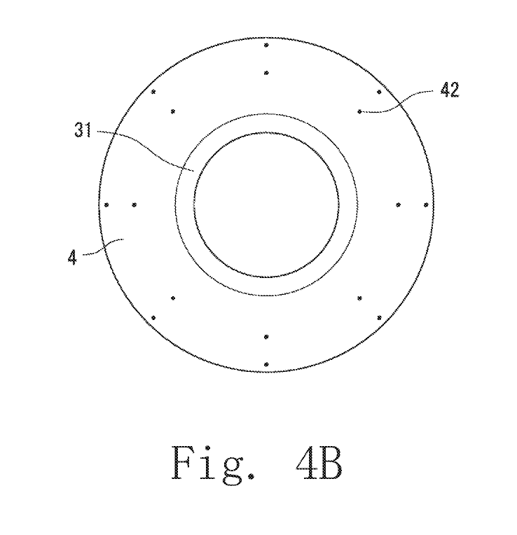

Next, an arrangement of the convex portions 42 will be described with reference to FIGS. 4A and 4B. FIG. 4A is a plan view illustrating an example of the arrangement of the convex portion 42 according to the first embodiment. FIG. 4B is a plan view illustrating another example of the arrangement of the convex portions 42 according to the first embodiment.

As illustrated in FIG. 4A, the support body 4 may have the plurality of convex portions 42 arranged in the circumferential direction. However, the number of the convex portions 42 and positions of the convex portions 42 are not limited as long as the rotating body 5 can be fixed. For example, the number of the convex portions 42 may be one. Further, each row having the plurality of convex portions 42 aligned in the radial direction may be arranged in the circumferential direction as illustrated in FIG. 4B. In other words, the plurality of convex portions 42 may be arranged in a radial shape. Preferably, the convex portions 42 are arranged such that the flow of air moving inside the rotating body 5 is hardly inhibited by the convex portions 42. Since the convex portions 42 are arranged in the radial direction as illustrated in FIG. 4B, the flow of air moving inside the rotating body 5 is hardly inhibited.

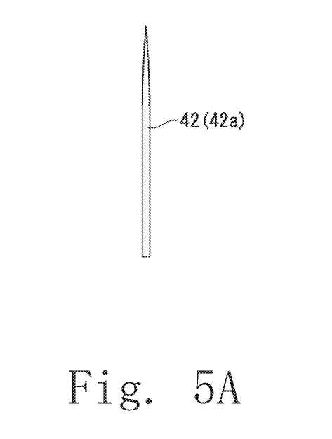

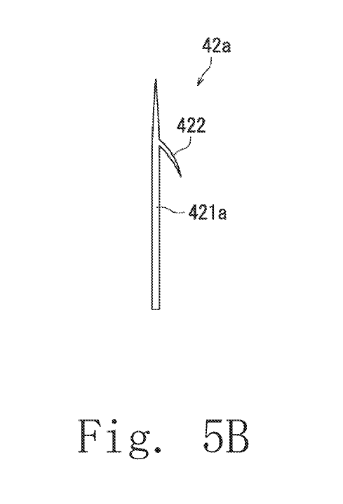

Next, a shape of the convex portion 42 will be described with reference to FIGS. 5A and 5B. FIG. 5A is a side view illustrating the convex portion 42 according to the first embodiment. FIG. 5B is a side view illustrating another example of the convex portion 42 according to the first embodiment.

As illustrated in FIG. 5A, the convex portion 42 according to the first embodiment has a needle shape. In other words, the convex portion 42 according to the first embodiment is elongated and pointed. Since the convex portion 42 has the needle shape, the pores of the rotating body 5 are hardly damaged by the convex portion 42. In the following description, the needle-shaped convex portion 42 may be referred to as a “first convex portion 42a” in some cases.

It is preferable that a diameter of the first convex portion 42a be smaller than an average pore diameter of the rotating body 5. Since the diameter of the first convex portion 42a is smaller than the average pore diameter of the rotating body 5, the pores of the rotating body 5 are hardly damaged by the first convex portion 42a.

As illustrated in FIG. 5B, the first convex portion 42a may have a protrusion 422. The first convex portion 42a illustrated in FIG. 5B includes a main body 421a and the protrusion 422. The main body 421a has a needle shape and extends axially upward. The protrusion 422 extends from the main body 421a in a direction opposite to the direction in which the first convex portion 42a (main body 421a) extends. Since the convex portion 42 has the protrusion 422, the rotating body 5 is hardly removed in the axial direction. The protrusion 422 may extend from the main body 421a in a direction perpendicular to the direction in which the first convex portion 42a (main body 421a) extends.

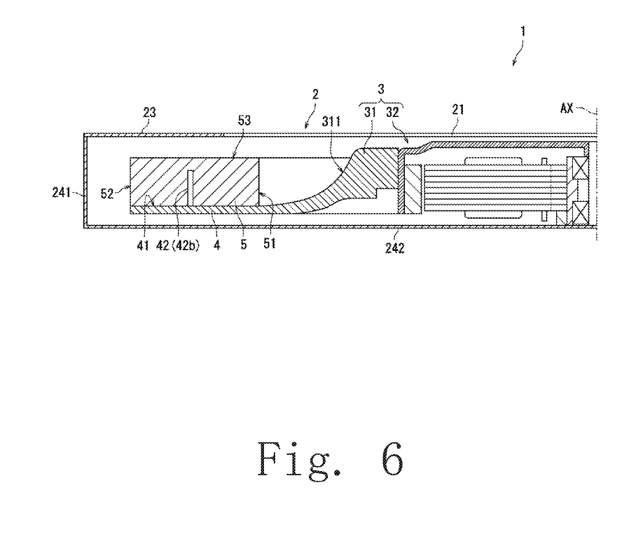

Next, a second embodiment of the present disclosure will be described with reference to FIGS. 6 to 8A, and 8B. However, items different from those of the first embodiment will be described, and descriptions for the same items as those of the first embodiment will be omitted. The second embodiment is different from the first embodiment in terms of the convex portion 42.

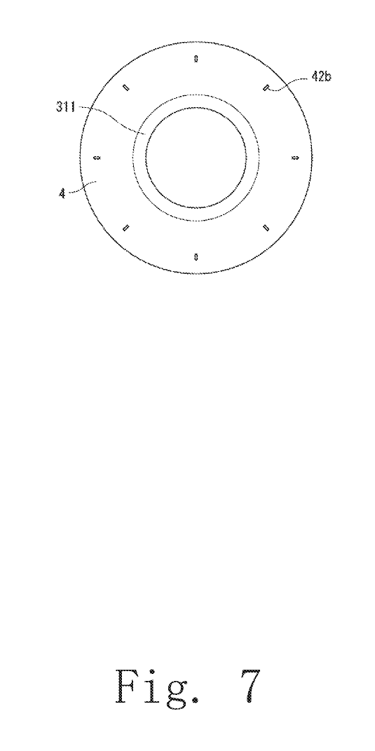

FIG. 6 is a cross-sectional view illustrating a portion of the centrifugal fan 1 according to the second embodiment. Specifically, FIG. 6 illustrates cross sections of the housing 2, the motor 3, the support body 4, and the rotating body 5. FIG. 7 is a plan view illustrating an example of an arrangement of the convex portions 42 according to the second embodiment.

As illustrated in FIGS. 6 and 7, the convex portion 42 according to the second embodiment has a flat plate shape extending in the radial direction. A width of the flat plate-shaped convex portion 42 in the radial direction is shorter than a width of the rotating body 5 in the radial direction. For example, the width of the flat plate-shaped convex portion 42 in the radial direction may be ⅓ of the radial width of the rotating body 5 or smaller. In the following description, the flat plate-shaped convex portion 42 may be referred to as a “second convex portion 42b” in some cases.

As illustrated in FIG. 7, the support body 4 may have a plurality of the second convex portions 42b arranged in the circumferential direction. However, the number of the second convex portions 42b and positions of the second convex portions 42b are not limited as long as the rotating body 5 can be fixed. For example, the number of the second convex portions 42b may be one.

The second embodiment has been described above with reference to FIGS. 6 and 7. According to the present embodiment, the second convex portion 42b pierces the rotating body 5 so that the rotating body 5 can be fixed to be replaceable. Further, since the shape of the second convex portion 42b is the flat plate shape extending in the radial direction, the flow of air moving in the radial direction inside the rotating body 5 is hardly inhibited by the convex portion 42. Incidentally, it is preferable that a thickness of the second convex portion 42b in the circumferential direction be smaller than an average pore diameter of the rotating body 5. Since the thickness of the second convex portion 42b in the circumferential direction is smaller than the average pore diameter of the rotating body 5, the flow of air moving in the radial direction inside the rotating body 5 is hardly inhibited by the convex portion 42.

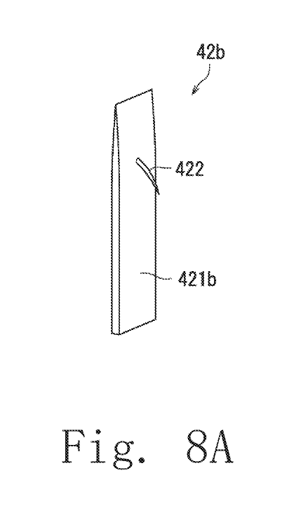

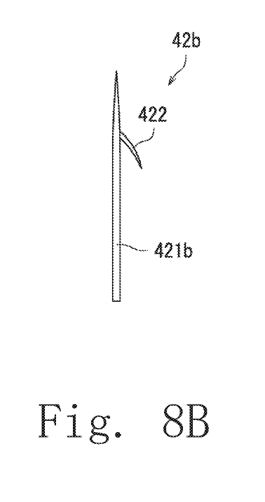

Next, another example of the second convex portion 42b will be described with reference to FIGS. 8A and 8B. FIG. 8A is a perspective view illustrating another example of the second convex portion 42b according to the second embodiment. FIG. 8B is a side view illustrating another example of the second convex portion 42b according to the second embodiment.

As illustrated in FIGS. 8A and 8B, the second convex portion 42b may have the protrusion 422 similarly to the first convex portion 42a which has been described with reference to FIG. 5B. The second convex portion 42b illustrated in FIGS. 8A and 8B includes a main body 421b and the protrusion 422. The main body 421b has a flat plate shape and extends axially upward. The protrusion 422 extends from the main body 421b in a direction opposite to the direction in which the second convex portion 42b (main body 421b) extends. Since the second convex portion 42b has the protrusion 422, the rotating body 5 is hardly removed in the axial direction. The protrusion 422 may extend from the main body 421b in a direction perpendicular to the direction in which the second convex portion 42b (main body 421b) extends.

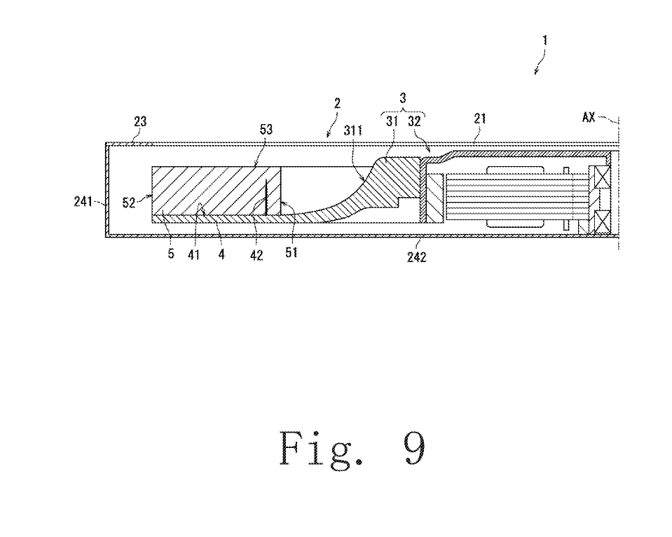

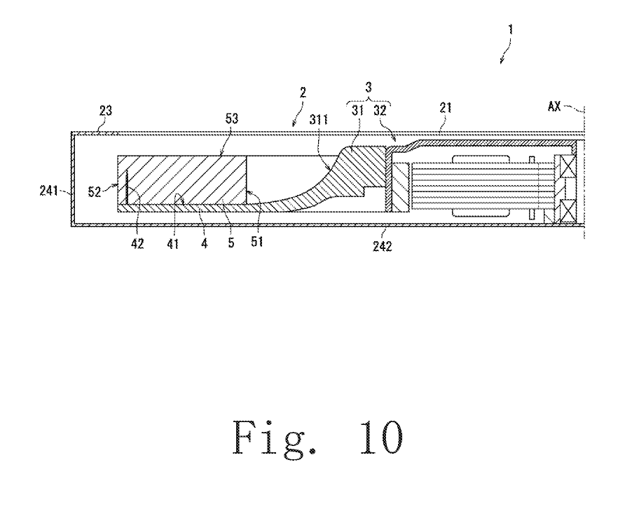

Next, a third embodiment of the present disclosure will be described with reference to FIGS. 9 and 10. However, items different from those of the first and second embodiments will be described, and descriptions for the same items as those of the first and second embodiments will be omitted. The third embodiment is different from the first and second embodiments in terms of the air inlet 21.

FIG. 9 is a cross-sectional view illustrating a portion of the centrifugal fan 1 according to the third embodiment. Specifically, FIG. 9 illustrates cross sections of the housing 2, the motor 3, the support body 4, and the rotating body 5.

As illustrated in FIG. 9, an inner diameter of the rotating body 5 is smaller than an opening diameter of the air inlet 21, and the convex portion 42 is arranged in a region where the air inlet 21 and the rotating body 5 overlap each other in the axial direction in the present embodiment. The inner diameter of the rotating body 5 indicates a distance from the central axis AX to the radially inner surface 51 of the rotating body 5. Further, the opening diameter of the air inlet 21 indicates a distance from the central axis AX to an edge of the air inlet 21.

According to the present embodiment, the inner diameter of the rotating body 5 is smaller than the opening diameter of the air inlet 21, and the convex portion 42 is arranged in the region where the air inlet 21 and the rotating body 5 overlap each other in the axial direction. As a result, the replacement of the rotating body 5 becomes easy as compared with the case where the inner diameter of the rotating body 5 is larger than the opening diameter of the air inlet 21. Further, since the inner diameter of the rotating body 5 is smaller than the opening diameter of the air inlet 21, the air inlet 21 can be used as a mark for positioning the rotating body 5.

In the example illustrated in FIG. 9, the convex portion 42 is arranged at a position closer to the radially inner surface 51 of the rotating body 5 than the radially outer surface 52 of the rotating body 5. However, the position at which the convex portion 42 is arranged is not limited as long as the position is a position within the region where the air inlet 21 and the rotating body 5 overlap each other in the axial direction. FIG. 10 is a cross-sectional view illustrating another example of an arrangement of the convex portions 42 according to the third embodiment. As illustrated in FIG. 10, for example, the convex portion 42 may be arranged at a position closer to the radially outer surface 52 of the rotating body 5 than the radially inner surface 51 of the rotating body 5.

It is preferable that an outer diameter of the rotating body 5 be equal to or smaller than the opening diameter of the air inlet 21. The outer diameter of the rotating body 5 indicates a distance from the central axis AX to the radially outer surface 52 of the rotating body 5. Since the outer diameter of the rotating body 5 is equal to or smaller than the opening diameter of the air inlet 21, the work of replacing the rotating body 5 via the air inlet 21 becomes easy.

More preferably, the outer diameter of the rotating body 5 coincides with the opening diameter of the air inlet 21. Since the outer diameter of the rotating body 5 coincides with the opening diameter of the air inlet 21, the amount of air blowing can be increased as compared with the case where the outer diameter of the rotating body 5 is smaller than the opening diameter of the air inlet 21. Incidentally, when a material of the rotating body 5 is a soft material such as an open-cell structure, the outer diameter of the rotating body 5 may be larger than the opening diameter of the air inlet 21. Since the outer diameter of the rotating body 5 is larger than the opening diameter of the air inlet 21, the amount of air blowing can be increased. Further, when the material of the rotating body 5 is the soft material such as the open-cell structure, the rotating body 5 can be replaced via the air inlet 21 even if the outer diameter of the rotating body 5 is larger than the opening diameter of the air inlet 21.

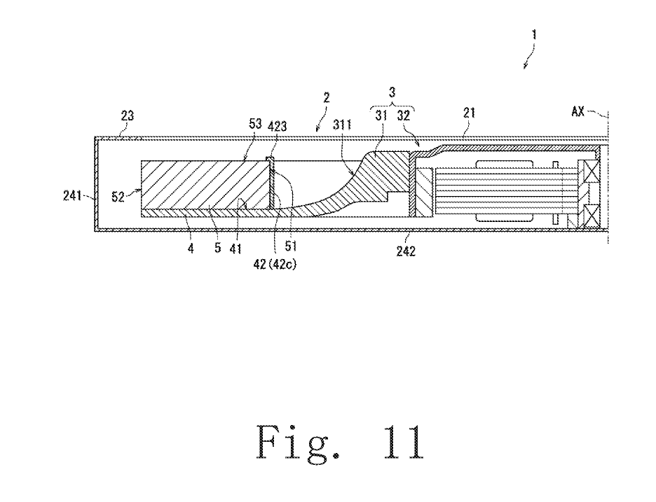

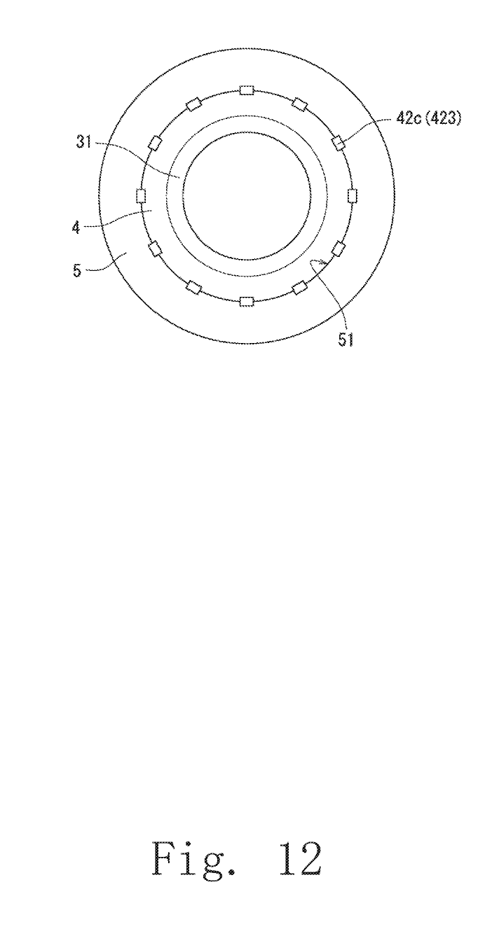

Next, a fourth embodiment of the present disclosure will be described with reference to FIGS. 11 and 12. However, items different from those of the first to third embodiments will be described, and descriptions for the same items as those of the first to third embodiments will be omitted. The fourth embodiment is different from the first to third embodiment in terms of the convex portion 42.

FIG. 11 is a cross-sectional view illustrating a portion of the centrifugal fan 1 according to the fourth embodiment. Specifically, FIG. 11 illustrates cross sections of the housing 2, the motor 3, the support body 4, and the rotating body 5.

As illustrated in FIG. 11, an inner diameter of the rotating body 5 is smaller than an opening diameter of the air inlet 21 in the present embodiment. Further, the convex portion 42 comes into contact with the radially inner surface 51 of the rotating body 5. Hereinafter, the convex portion 42 that comes into contact with the radially inner surface 51 of the rotating body 5 may be referred to as a “third convex portion 42c” in some cases.

In the present embodiment, the third convex portion 42c has a hook portion 423 as illustrated in FIG. 11. The hook portion 423 is provided in an axially upper portion of the third convex portion 42c. The hook portion 423 comes into contact with an edge portion of the axially upper surface 53 of the rotating body 5. Since the third convex portion 42c has the hook portion 423, the rotating body 5 can be more stably fixed.

Next, an arrangement of the convex portions 42 according to the fourth embodiment will be described with reference to FIG. 12. FIG. 12 is a plan view illustrating the arrangement of the convex portion 42 according to the fourth embodiment. In the present embodiment, the support body 4 has a plurality of the third convex portions 42c as illustrated in FIG. 12. The plurality of third convex portions 42c is arranged in the circumferential direction and comes into contact with the radially inner surface 51 of the rotating body 5. The plurality of third convex portions 42c is arranged in the circumferential direction and comes into contact with the radially inner surface 51 of the rotating body 5 so that the rotating body 5 can be more stably fixed.

The number of the third convex portions 42c and a length of the third convex portion 42c in the circumferential direction are not limited as long as the rotating body 5 can be fixed. However, the flow of air sucked into the rotating body 5 from the radially inner surface 51 of the rotating body 5 is inhibited as the area of the radially inner surface 51 of the rotating body 5 covered with the third convex portion 42c increases. Therefore, preferably, the number of the third convex portions 42c and the length thereof in the circumferential direction are determined such that the degree of inhibition of the flow of air sucked into the rotating body 5 is low.

The fourth embodiment has been described above with reference to FIGS. 11 and 12. Since the support body 4 has the third convex portion 42c according to the present embodiment, the rotating body 5 can be fixed to be replaceable. Further, the radially inner surface 51 of the rotating body 5 is brought into contact with the convex portion 42 when fixing the rotating body 5 to the support body 4. Therefore, since the convex portion 42 serves as a mark for positioning the radially inner surface 51 of the rotating body 5, the work of replacing the rotating body 5 becomes easy.

Further, the inner diameter of the rotating body 5 is smaller than the opening diameter of the air inlet 21 according to the present embodiment so that the replacement of the rotating body 5 becomes easy as compared with the case where the inner diameter of the rotating body 5 is larger than the opening diameter of the air inlet 21. Further, the air inlet 21 can be used as the mark for positioning the rotating body 5.

According to the present embodiment, stress acting on the rotating body 5 by a centrifugal force is only a tensile load, and thus, it is possible to suppress deformation of the rotating body 5. For example, when the convex portion 42 is positioned between the radially inner surface 51 and the radially outer surface 52 of the rotating body 5, a compressive load acts on a portion of the rotating body 5 between the convex portion 42 and the radially inner surface 51, and the tensile load acts on a portion between the convex portion 42 and the radially outer surface 52.

Incidentally, the third convex portion 42c may have the protrusion 422 similarly to the first convex portion 42a which has been described with reference to FIG. 5B.

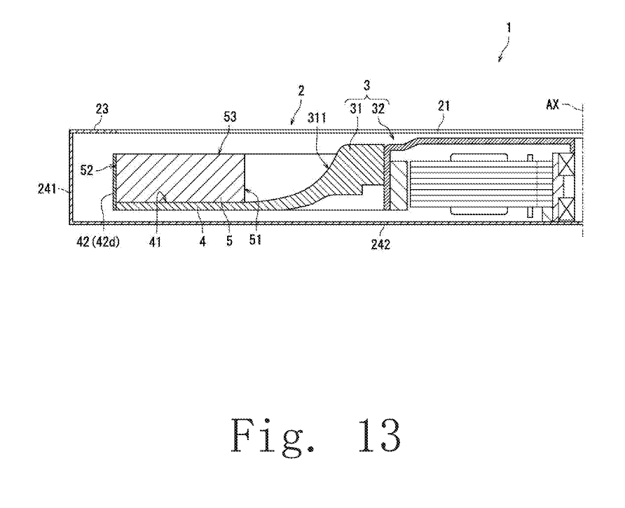

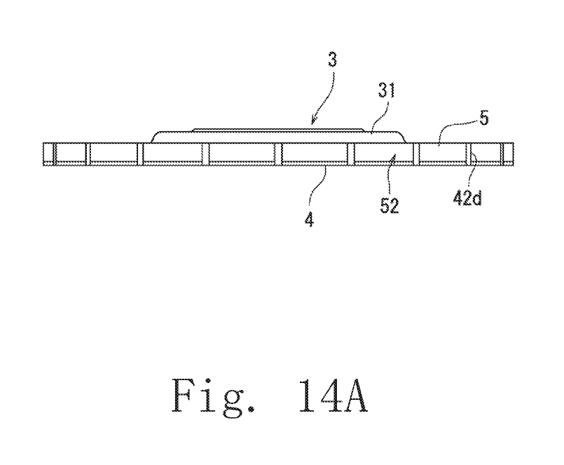

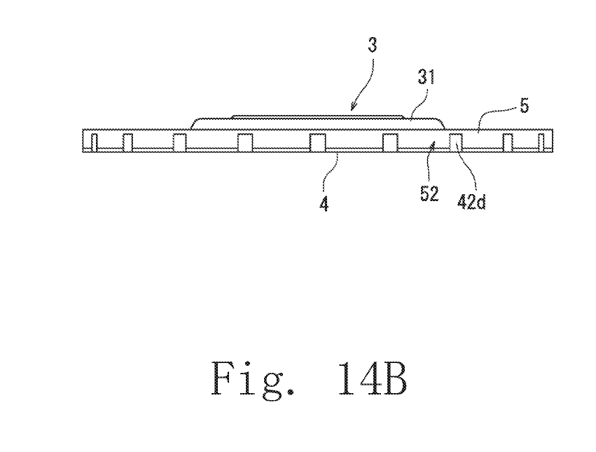

Next, a fifth embodiment of the present disclosure will be described with reference to FIGS. 13, 14A, and 14B. However, items different from those of the first to fourth embodiments will be described, and descriptions for the same items as those of the first to fourth embodiments will be omitted. The fifth embodiment is different from the first to fourth embodiment in terms of the convex portion 42.

FIG. 13 is a cross-sectional view illustrating a portion of the centrifugal fan 1 according to the fifth embodiment. Specifically, FIG. 13 illustrates cross sections of the housing 2, the motor 3, the support body 4, and the rotating body 5.

As illustrated in FIG. 13, an inner diameter of the rotating body 5 is smaller than an opening diameter of the air inlet 21. Further, the convex portion 42 comes into contact with the radially outer surface 52 of the rotating body 5. Hereinafter, the convex portion 42 that comes into contact with the radially outer surface 52 of the rotating body 5 may be referred to as a “fourth convex portion 42d”. In the present embodiment, a length of the fourth convex portion 42d in the axial direction is equal to a length of the rotating body 5 in the axial direction.

Next, an arrangement of the convex portions 42 according to the fifth embodiment will be described with reference to FIG. 14A. FIG. 14A is a plan view illustrating the arrangement of the convex portions 42 according to the fifth embodiment. In the present embodiment, the support body 4 has a plurality of the fourth convex portions 42d as illustrated in FIG. 14A. The plurality of fourth convex portions 42d is arranged in the circumferential direction and comes into contact with the radially outer surface 52 of the rotating body 5. The plurality of fourth convex portions 42d is arranged in the circumferential direction and comes into contact with the radially outer surface 52 of the rotating body 5 so that the rotating body 5 can be more stably fixed.

The number of the fourth convex portions 42d and the length of the fourth convex portion 42d in the circumferential direction are not limited as long as the rotating body 5 can be fixed. However, the flow of air sent out from the radially outer surface 52 to the outside of the rotating body 5 is inhibited as the area of the radially outer surface 52 of the rotating body 5 covered with the fourth convex portion 42d increases. Therefore, preferably, the number of the fourth convex portions 42d and the length thereof in the circumferential direction are determined such that the degree of inhibition of the flow of air sent out from the rotating body 5 to the outside is low.

The fifth embodiment has been described above with reference to FIGS. 13 and 14A. Since the support body 4 has the fourth convex portion 42d according to the present embodiment, the rotating body 5 can be fixed to be replaceable. Further, the radially outer surface 52 of the rotating body 5 comes into contact with the fourth convex portion 42d when fixing the rotating body 5 to the support body 4. Therefore, since the fourth convex portion 42d serves as a mark for positioning the radially outer surface 52 of the rotating body 5, the work of replacing the rotating body 5 becomes easy.

Further, the inner diameter of the rotating body 5 is smaller than the opening diameter of the air inlet 21 according to the present embodiment. As a result, the replacement of the rotating body 5 becomes easy as compared with the case where the inner diameter of the rotating body 5 is larger than the opening diameter of the air inlet 21. Further, the air inlet 21 can be used as the mark for positioning the rotating body 5.

According to the present embodiment, stress acting on the rotating body 5 by a centrifugal force is only a compressive load, and thus, it is possible to suppress deformation of the rotating body 5.

Incidentally, the fourth convex portion 42d may have the protrusion 422 similarly to the first convex portion 42a which has been described with reference to FIG. 5B. Further, the hook portion 423 may be provided similarly to the third convex portion 42c which has been described with reference to FIG. 11.

Although the length of the fourth convex portion 42d in the axial direction coincides with the length of the rotating body 5 in the axial direction in the present embodiment, the length of the fourth convex portion 42d in the axial direction may be shorter than the length of the rotating body 5 in the axial direction as illustrated in FIG. 14B. FIG. 14B is a side view illustrating another example of the convex portion 42 according to the fifth embodiment. Meanwhile, it is preferable that the length of the fourth convex portion 42d in the axial direction be longer than a half of the length of the rotating body 5 in the axial direction. Since the length of the fourth convex portion 42d in the axial direction is longer than the half the length of the rotating body 5 in the axial direction, the center of gravity of the rotating body 5 is positioned within a range where the rotating body 5 is fixed by the fourth convex portion 42d, and thus, the rotating body 5 can be more stably fixed.

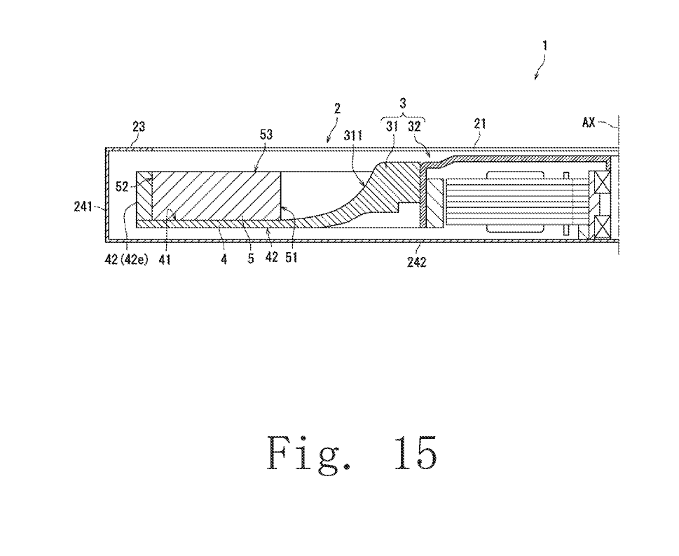

Next, a sixth embodiment of the present disclosure will be described with reference to FIG. 15. However, items different from those of the first to fifth embodiments will be described, and descriptions for the same items as those of the first to fifth embodiments will be omitted. The sixth embodiment is different from the first to fifth embodiment in terms of the convex portion 42.

FIG. 15 is a cross-sectional view illustrating a portion of the centrifugal fan 1 according to the sixth embodiment. Specifically, FIG. 15 illustrates cross sections of the housing 2, the motor 3, the support body 4, and the rotating body 5.

As illustrated in FIG. 15, the convex portion 42 according to the sixth embodiment comes into contact with the radially outer surface 52 of the rotating body 5. In the present embodiment, the convex portion 42 is formed of a continuous porous body. For example, a material of the convex portion 42 may be an open-cell structure. Since the open-cell structure is a material that is easily processed, it is possible to easily manufacture the convex portion 42 made of the continuous porous body by using the open-cell structure as the material of the convex portion 42. Hereinafter, the convex portion 42 made of the continuous porous body will be referred to as a “fifth convex portion 42e” in some cases.

In the present embodiment, a length of the fifth convex portion 42e in the axial direction is equal to a length of the rotating body 5 in the axial direction. However, the length of the fifth convex portion 42e in the axial direction may be shorter than the length of the rotating body 5 in the axial direction. Further, a length of the fifth convex portion 42e in the circumferential direction may coincide with a length of the radially outer surface 52 of the rotating body 5 in the circumferential direction or may be shorter than the length of the radially outer surface 52 of the rotating body 5 in the circumferential direction. Further, the support body 4 may have the single fifth convex portion 42e or a plurality of the fifth convex portions 42e.

The sixth embodiment has been described above with reference to FIG. 15. According to the present embodiment, the flow of the air sent out to the outside from the radially outer surface 52 of the rotating body 5 is hardly inhibited by the convex portion 42. Further, when the length of the fifth convex portion 42e in the circumferential direction coincides with the length of the radially outer surface 52 of the rotating body 5 in the circumferential direction, the entire surface of the radially outer surface 52 of the rotating body 5 can be held by the fifth convex portion 42e. Therefore, stress is prevented from being locally concentrated on the rotating body 5, and as a result, the rotating body 5 is hardly deformed.

According to the present embodiment, the fifth convex portion 42e exhibits the same function as the rotating body 5. In other words, a portion from the radially inner surface 51 of the rotating body 5 to a radially outer surface of the fifth convex portion 42e serves as the rotating body. Therefore, the amount of air blowing increases, and a PQ characteristic is improved. The PQ characteristic indicates a relationship between air volume and static pressure at the air inlet 21 and the air outlet 22. More specifically, when the rotor hub 31 rotates, the fifth convex portion 42e rotates in the circumferential direction about the central axis AX. When the fifth convex portion 42e rotates in the circumferential direction, the air inside the fifth convex portion 42e moves to the radially outer surface of the fifth convex portion 42e by a centrifugal force and is sent from the radially outer surface of the fifth convex portion 42e to the outside of the fifth convex portion 42e. As a result, the air sent from the radially outer surface 52 of the rotating body 5 is sucked into the inside of the fifth convex portion 42e from a radially inner surface of the fifth convex portion 42e.

Although the fifth convex portion 42e comes into contact with the radially outer surface 52 of the rotating body 5 in the present embodiment, the fifth convex portion 42e may come into contact with the radially inner surface 51 of the rotating body 5. When the fifth convex portion 42e comes into contact with the radially inner surface 51, the flow of air sucked into the rotating body 5 from the radially inner surface 51 of the rotating body 5 is hardly inhibited by the convex portion 42. Further, when the length of the fifth convex portion 42e in the circumferential direction coincides with the length of the radially inner surface 51 of the rotating body 5 in the circumferential direction, the entire surface of the radially inner surface 51 of the rotating body 5 can be held by the fifth convex portion 42e. Therefore, stress is prevented from being locally concentrated on the rotating body 5, and as a result, the rotating body 5 is hardly deformed.

When the fifth convex portion 42e comes into contact with the radially inner surface 51 of the rotating body 5, a portion from the radially inner surface of the fifth convex portion 42e to the radially outer surface 52 of the rotating body 5 serves as the rotating body. Therefore, the amount of air blowing increases, and a PQ characteristic is improved.

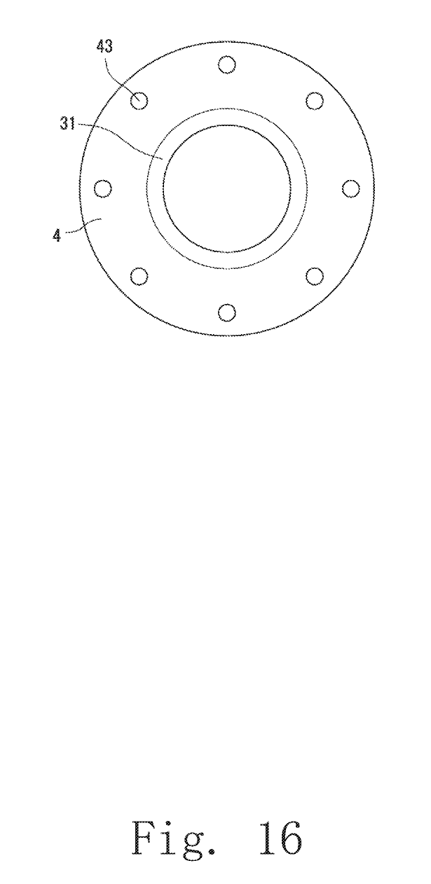

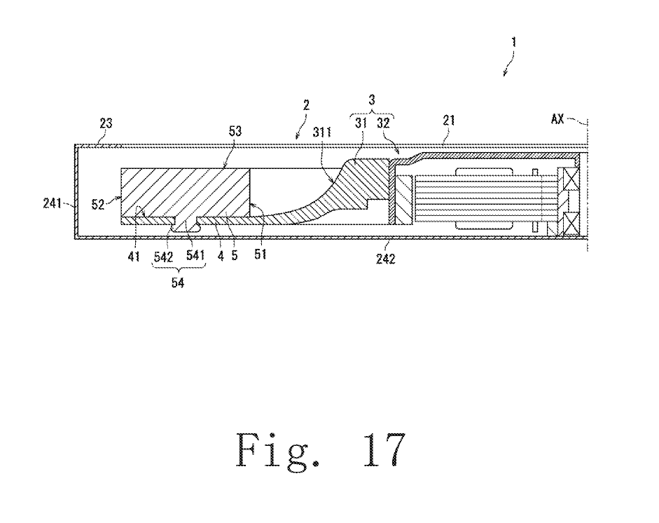

Next, a seventh embodiment of the present disclosure will be described with reference to FIGS. 16 and 17. However, items different from those of the first to sixth embodiments will be described, and descriptions for the same items as those of the first to sixth embodiments will be omitted. The seventh embodiment is different from the first to sixth embodiments in terms of the support body 4 and the rotating body 5.

FIG. 16 is a plan view illustrating the support body 4 according to the seventh embodiment. As illustrated in FIG. 16, the support body 4 has a through-hole 43. The through-hole 43 penetrates the support body 4 in the axial direction. In the present embodiment, the support body 4 has a plurality of the through-holes 43 arranged in the circumferential direction. The support body 4 may have the single through-hole 43.

FIG. 17 is a cross-sectional view illustrating a portion of the centrifugal fan 1 according to the seventh embodiment. FIG. 17 illustrates cross sections of the housing 2, the motor 3, the support body 4, and the rotating body 5.

As illustrated in FIG. 17, the rotating body 5 has a protruding portion 54 extending in the axial direction. Specifically, the protruding portion 54 protrudes axially downward from a surface of the rotating body 5 on the support body 4 side. The through-hole 43 described with reference to FIG. 16 opposes the rotating body 5 in the axial direction. The protruding portion 54 is inserted into the through-hole 43. According to the present embodiment, the rotating body 5 can be fixed to be replaceable by inserting the protruding portion 54 into the through-hole 43.

In the present embodiment, the protruding portion 54 is made of a soft material such as an open-cell structure. Further, the protruding portion 54 has a main body 541 and a distal end portion 542. The main body 541 protrudes axially downward from the surface of the rotating body 5 on the support body 4 side and is accommodated in the through-hole 43. The distal end portion 542 is provided at a distal end of the main body 541. Further, a diameter of the distal end portion 542 is larger than a diameter of the main body 541. Since the protruding portion 54 is made of the soft material such as the open-cell structure according to the present embodiment, the distal end portion 542 can be inserted into the through-hole 43 to pass therethrough to the outer side of the through-hole 43 even if the diameter of the distal end portion 542 is larger than the diameter of the main body 541. Further, since the diameter of the distal end portion 542 is larger than the diameter of the main body 541, the convex portion 54 hardly comes off from the through-hole 43. Therefore, the rotating body 5 can be more stably fixed.

The seventh embodiment has been described above with reference to FIGS. 16 and 17. According to the present embodiment, the rotating body 5 can be fixed to be replaceable.

The first to seventh embodiments of the present disclosure have been described above with reference to the drawings. However, the present disclosure is not limited to the above-described embodiments, and can be implemented in various modes without departing from a gist thereof.

For example, the respective items described with reference to the first to seventh embodiments can be appropriately combined. For example, the support body 4 may have the needle-shaped convex portion 42 (the first convex portion 42a) and the flat plate-like convex portion 42 (the second convex portion 42b). Alternatively, the support body 4 may have the convex portion 42 that comes into contact with the radially outer surface 52 of the rotating body 5 and the convex portion 42 that comes into contact with the radially inner surface 51 of the rotating body 5.

Although the housing 2 has the single air outlet 22 in the embodiments according to the present disclosure, the housing 2 may have a plurality of the air outlets 22.

The present disclosure is suitably applicable to, for example, a centrifugal fan.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A centrifugal fan comprising:
a motor including a rotor hub rotatable about a central axis extending up and down;
a support body fixed to the rotor hub and rotatable together with the rotor hub;
a rotating body made of a material different from a material of the support body and defined by a continuous porous body; and
a housing to house the rotating body, the support body, and the motor; wherein
the housing includes an air inlet open in an axial direction and at least one air outlet open in a radial direction;
a radially inner surface of the rotating body opposes a radially outer surface of the rotor hub with a gap interposed therebetween; and
the rotating body is fixed to the support body to be replaceable.

2. The centrifugal fan according to claim 1, wherein the support body includes at least one convex portion extending to a side of the air inlet.

3. The centrifugal fan according to claim 2, wherein the at least one convex portion is positioned on a side closer to a radially outer surface of the rotating body than the radially inner surface of the rotating body and on a side closer to the radially inner surface of the rotating body than the radially outer surface of the rotating body.

4. The centrifugal fan according to claim 2, wherein the at least one convex portion has a needle shape.

5. The centrifugal fan according to claim 2, wherein
a shape of the at least one convex portion is a flat plate shape extending in the radial direction; and
a width of the at least one convex portion in the radial direction is shorter than a width of the rotating body in the radial direction.

6. The centrifugal fan according to claim 2, wherein a length of the at least one convex portion in the axial direction is longer than a half of a length of the rotating body in the axial direction.

7. The centrifugal fan according to claim 2, wherein
an inner diameter of the rotating body is smaller than an opening diameter of the air inlet; and
the convex portion is located in a region where the air inlet and the rotating body overlap each other in the axial direction.

8. The centrifugal fan according to claim 2, wherein the at least one convex portion comes into contact with at least one of the radially inner surface and a radially outer surface of the rotating body.

9. The centrifugal fan according to claim 2, wherein
the support body includes a plurality of the convex portions; and
the plurality of convex portions is arranged in a circumferential direction and contacts with at least one of the radially inner surface and a radially outer surface of the rotating body.

10. The centrifugal fan according to claim 2, wherein the convex portion includes a protrusion extending in a direction perpendicular or opposite to a direction in which the convex portion extends.

11. The centrifugal fan according to claim 8, wherein the at least one convex portion includes a continuous porous body.

12. The centrifugal fan according to claim 11, wherein a material of the at least one convex portion includes an open-cell structure.

13. The centrifugal fan according to claim 1, wherein
the support body includes a through-hole penetrating in the axial direction;
the rotating body includes a protruding portion extending in the axial direction;
the support body opposes the rotating body in the axial direction; and
the protruding portion is inserted into the through-hole.

14. The centrifugal fan according to claim 1, wherein an inner diameter of the rotating body is smaller than an opening diameter of the air inlet.

15. The centrifugal fan according to claim 14, wherein an outer diameter of the rotating body is equal to or larger than the opening diameter of the air inlet.

16. The centrifugal fan according to claim 1, wherein a material of the rotating body includes an open-cell structure.
